(19) United States
(12) Patent Application Publication
(10) Pub. No.: US 2009/0295681 A1
(43) Pub. Date: Dec. 3, 2009

(54) Virtual Image System for Windshields

(75) Inventors: Paul R. Kaminski, St. Clair Shores, MI (US); Steven A. Stringfellow, Oakland, MI (US); Davide Silvestri, Macomb, MI (US); Susan Livingston, Clarkston, MI (US)

Correspondence Address: GENERAL MOTORS COMPANY;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 12/127,188

(22) Filed: May 27, 2008

(51) Int. Cl. G09G 5/00; B32B 17/06

(52) U.S. Cl. 345/7; 428/426

(57) ABSTRACT

A virtual image system for windshields that permits an image source to reflect off the windshield so that a virtual image, free of ghost image, is visible to the driver. Either a matte black material is applied to a windshield glass pane at any of the outer glass pane windshield surfaces 1 or 2, or at the inner glass pane windshield surface 3, or else a black glossy sheet is disposed at windshield surface 4 upon the windshield frit, whereby the virtual image is provided for any image source having real image rays incident at windshield surface 4.

### TECHNICAL FIELD

The present invention relates to windshields, particularly those utilized for motor vehicles, and more particularly to a virtual image system which permits illuminated images to be reflected at the windshield and thereupon be visible without a ghost image being seen by the driver.

### BACKGROUND OF THE INVENTION

As shown by way of example at FIG. 1, motor vehicle windshields 10 are a laminate, composed of an outer glass pane 12, an inner glass pane 14, and a plastic layer 16 therebetween which is heat bonded thereto. The glass panes 12, 14 are of a safety glass material (i.e., tempered glass), which are optically clear and may be selectively tinted. By convention, windshield surface “1” is disposed at the outer surface 12a of the outer glass pane 12 (i.e., facing the external environment), windshield surface “2” is disposed at the inner surface 12b of the outer glass pane 12 where it abuts the plastic layer 16, windshield surface “3” is disposed at the outer surface 14a of the inner glass pane 14 where it abuts the plastic layer 16 opposite the outer glass pane, and windshield surface “4” is disposed at the inner surface 14b of the inner glass pane 14 (facing the interior of the passenger compartment).

The plastic layer 16 is commonly composed of a polymer resin material known as polyvinyl butyral (PVB), but may be otherwise. The plastic layer 16 is optically clear, but may be dyed (i.e., a blue sunscreen tint). The plastic layer 16 provides a safety feature with respect to keeping the glass panes bonded thereto in the event of an untoward incident in which the glass breaks or fragments. A frit 18 is usually provided at the periphery of the windshield 10 to provide an black opaque area which hides the adhesive sealant. The frit 18 is a black commonly ceramic powder based material, for example composed of a lead and chromate based ceramic ink or of a water based ceramic ink, which is silk screened onto the windshield, then heated in a furnace to cause it to etch (or frost) into the glass at windshield surface 4 (i.e., the inner surface 14b of the inner glass pane 14). While the frit 18 has a rough, matte black finish when viewed directly at windshield surface 4 from inside the passenger compartment, when viewed through the windshield at windshield surface 1, the frit appears to be glossy, even though it is matte.

In the engineering of heads-up displays (HUDs), an image is generated at an image source (not shown, but usually located for example in a hidden well in the dash board adjacent the windshield), and the light rays therefrom are reflected off the windshield so that a virtual image is clearly visible to the driver. A problem that needs to be solved in this regard, however, is the elimination of a ghost virtual image of the primary virtual image. FIGS. 1A and 1B show examples of how ghost images occur. The real light rays 22 of the image from the image source are reflected at windshield surface 4, providing primary virtual image rays 24 to the driver which are seen as a primary virtual image 26. However, at FIG. 1A, if, by way of example, a black glossy surface 28 is disposed at windshield surface 1, or if a black glossy surface 28′ is disposed at windshield surface 2 or 3 (as shown), then the refracted rays 20 are reflected therefrom and exit the windshield as “ghost” (i.e., secondary) virtual image rays 20a which are seen by the driver as a ghost virtual image 30. The driver will see both the primary virtual image 26 and the ghost virtual image 30, wherein the ghost virtual image will be laterally off-set in relation to the primary virtual image. This result is very undesirable. One solution in the art to avoid a ghost virtual image has been to orient the outer glass pane 12 other than parallel to the inner glass pane 14 with an accommodating plastic layer 16′, wherein the acute angle is chosen so that the reflected rays 24 and the exit direction of the refracted rays 20 coincide, wherein a single virtual image 32 is seen by the driver, as shown by way of schematic example at FIG. 1C.

Therefore, what remains needed in the art is a virtual image system for windshields that permits an image source to reflect off the windshield so that only the primary virtual image is visible to the driver (there being no ghost virtual image), and without acutely angling the inner and outer glass panes in relation to each other.

### SUMMARY OF THE INVENTION

The present invention is a virtual image system for laminated windshields that permits an image produced by an image source to reflect off the windshield so that only a single virtual image thereof is visible to the driver, wherein the outer and inner glass panes may be disposed parallel to each other.

In order to provide a high head down virtual image display on a laminated windshield without acutely angled outer and inner glass panes and without the appearance of a ghost (i.e., secondary) virtual image, wherein the single virtual image is a crisp and faithful reproduction of the actual image generated at an image source (located, for example, at a hidden well in a dashboard of the instrument panel), either a matte black material is applied to a windshield glass pane at any of windshield surfaces 1, 2 or 3, or else a black glossy sheet is disposed at windshield surface 4, wherein a single virtual image is provided for any image source generating an image (i.e., LED, LCD, VF, OLED, etc.), wherein the image may be, but is not limited to, one or more telltale images.

The virtual image system according to the present invention provides a high contrast virtual image to the driver, the image seemingly being through the windshield, which is not washed out by sunlight and allows the driver to see the image at a distance whereby minimal head-down movement is required, having the benefits of a HUD without image washout, and wherein for anticipatory compliance with possible regulations, the virtual image is very low on the windshield (i.e., generally adjacent the base (bottom) of the windshield) so as to not affect the driver's general view of the road.

Accordingly, it is an object of the present invention to provide a virtual image system for windshields that permits an image from an image source to reflect off the windshield so that only a single virtual image is visible to the driver, without the drawbacks associated with HUDs.

This and additional objects, features and advantages of the present invention will become clearer from the following specification of a preferred embodiment.

### BRIEF DESCRIPTION OF THE DRAWINGS

FIG. 1 is a sectional side view of a conventional laminated windshield with a peripheral frit.

FIG. 1A is a sectional side view of a conventional laminated windshield, in which a glossy sheet on surface 1 provides a reflective surface generating both primary and ghost virtual images.

FIG. 1B is a sectional side view of a conventional laminated windshield, in which a glossy sheet on surface 3 provides a reflective surface generating both primary and ghost virtual images.

FIG. 1C is a sectional side view of a conventional laminated windshield for a HUD.

FIG. 2 is a sectional side view of an environment of operation of the virtual image system according to a first aspect of the present invention.

FIG. 2A is a detail view of the first aspect of the present invention, seen at circle 2A of FIG. 2.

FIG. 3 is a sectional side view of an environment of operation of the virtual image system according to a second aspect of the present invention.

FIG. 3A is a detail view of the second aspect of the present invention, seen at circle 3A of FIG. 3.

FIG. 4 is a sectional side view of an environment of operation of the virtual image system according to a third aspect of the present invention.

FIG. 4A is a detail view of a first application of the third aspect of the present invention, seen at circle 4A-4B of FIG. 4.

FIG. 4B is a detail view of a first application of the third aspect of the present invention, also seen at circle 4A-4B of FIG. 4.

FIG. 5 is a side view of the virtual image system according to the present invention, shown in operation providing virtual images of telltales with respect to a windshield as seen from a driver's sighted position (i.e., vantage point).

### DESCRIPTION OF THE PREFERRED EMBODIMENT

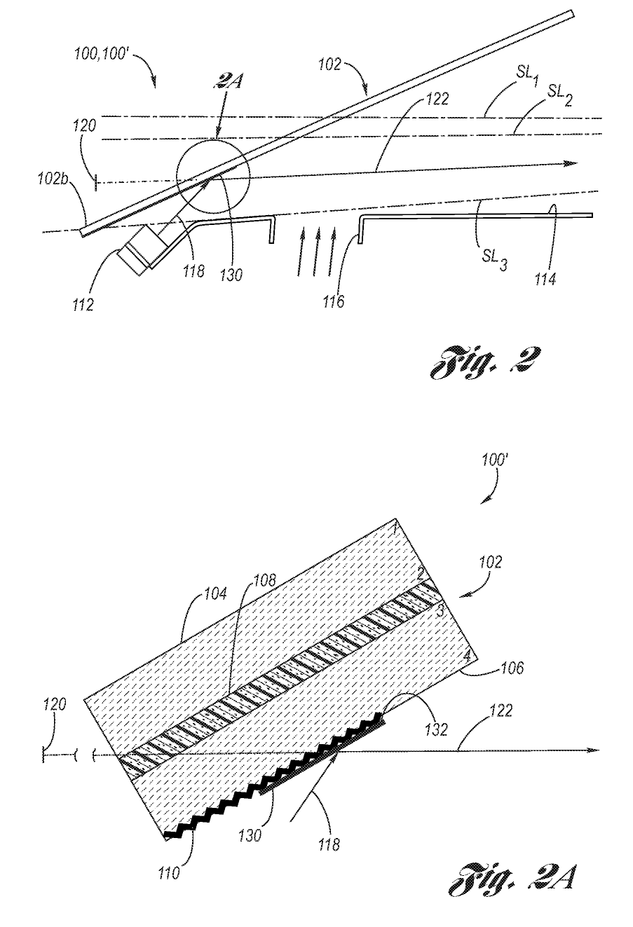

Referring now to the Drawing, FIGS. 2 through 5 depict various aspects of an example of an virtual image system 100 for laminated windshields which permits an image from an image source to reflect off the windshield so that only a single virtual image thereof is visible to the driver, wherein the outer and inner glass panes of the windshield may be disposed parallel to each other. As described hereinbelow with respect to FIGS. 2 through 5, generally: like parts have like numeral designations, modified like parts will have like numerals with priming, and different parts will have different numeral designations.

Of consideration regarding the practice of the present invention, are: elimination of a ghost image (as defined hereinabove), the angle of view of the driver with respect to viewing of the virtual image, minimization or elimination of sunlight washout of the virtual image, and the location of the virtual image with respect to the base (i.e., lower periphery) of the windshield. In this regard generally as pertains to each of FIGS. 2, 3 and 4, the positioning of the virtual image includes consideration of: sightline SL₁ which represents a 4 degree down angle from a selected driver sighted position, wherein thereabove a clear and unobstructed view of the road ahead is preferably provided; and sightlines SL₂ and SL₃, wherein sightline SL₂ represents a 5 degree down angle from the selected driver sighted position, and sightline SL₃ represents a lowest visible sightline from the selected driver sighted position, wherein the virtual image is desired to be generally centrally disposed between sightlines SL₂ and SL₃.

Referring firstly to FIGS. 2 and 2A, a first aspect 100′ of the virtual image system 100 is depicted.

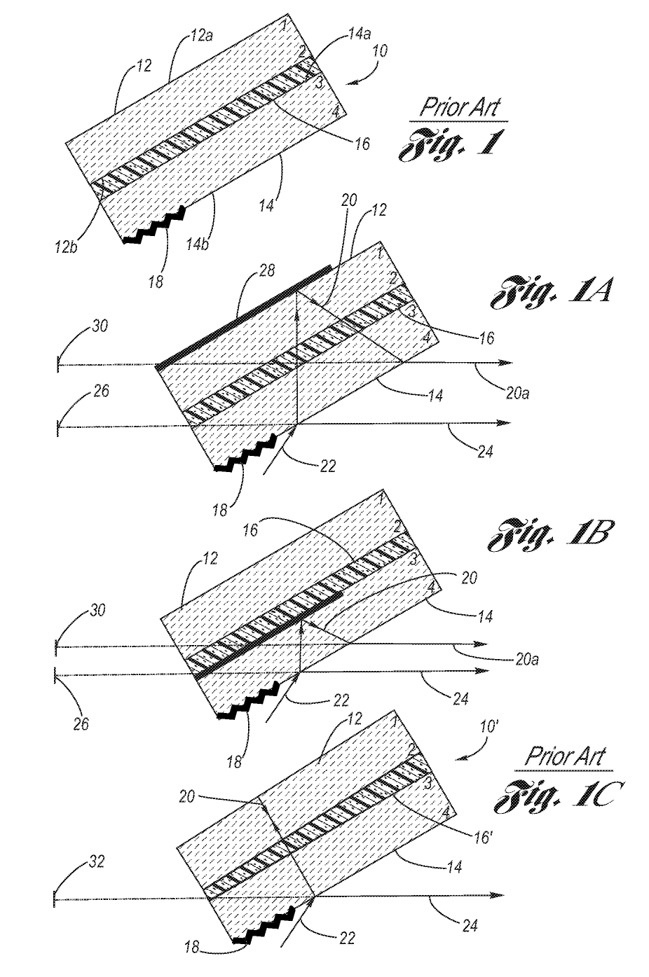

A laminated windshield 102 is composed of an outer glass pane 104, an inner glass pane 106, a plastic layer 108 therebetween, and a peripheral frit 110, wherein the windshield has surfaces 1, 2, 3 and 4, as generally described hereinabove with respect to FIG. 1. An image source 112 is packaged and mounted within the dashboard 114 of the instrument panel in such a manner (taking due regard for the defrost vent 116) that neither the driver nor an occupant in the passenger compartment will have a direct view of the image source, which may be, for non-limiting example, LED, LCD, VF, OLED, etc. The image source 112 produces real image rays 118 which reflect at the windshield 102 such that a virtual image 120 thereof is viewable to the driver along virtual image rays 122 without a ghost image (virtual or real) being visible to the driver.

In order to provide a high head down virtual image 120 on the laminated windshield 102 without acutely angled outer and inner glass panes and without the appearance of a ghost (i.e., secondary) virtual image, wherein the single virtual image is a crisp, and faithful reproduction of the actual image generated by the image source 112, a black glossy sheet 130 is disposed at windshield surface 4 adjacent the base 102b of the windshield, within the region between sightlines SL₁ and SL₂.

A preferred material for the black glossy sheet 130 (other materials may be used) is a self-adhering mylar applique which adheres to the windshield frit 110 by means of pressure sensitive adhesive backing 132, wherein the dimensions may be (by way of nonlimiting example) 250 mm wide by 80 mm tall, is thick enough to not register rough/irregular black-out frit surface at the surface thereof as viewed by the driver, and is further thick enough so that small bubbles therebehind will not be seen, wherein the gloss level may be an 80% gloss level (GLW), having a “smooth” grain, and “jet black” color.

In order that the black glossy sheet 130 will have a class “A” appearance to an onlooker who sees into the windshield from the windshield surface 1, it is preferred for the frit 110 to be at least coextensive with the black glossy sheet 130. This make take the form of the frit 110 being already thereat independently of placement of the black glossy sheet, or for the frit to be placed at an elevation which specifically takes into account the presence of the black glossy sheet 130.

In operation, the real image rays 118 from the image source strike the black glossy sheet 130, whereupon under the well known “Law of Reflection”, wherein the angle of incidence equals the angle of reflection, reflection transpires such that the virtual image rays 122 travel to the driver's eyes, and are seen by the driver as a virtual image 120 without a ghost image (virtual or real) being visible to the driver.

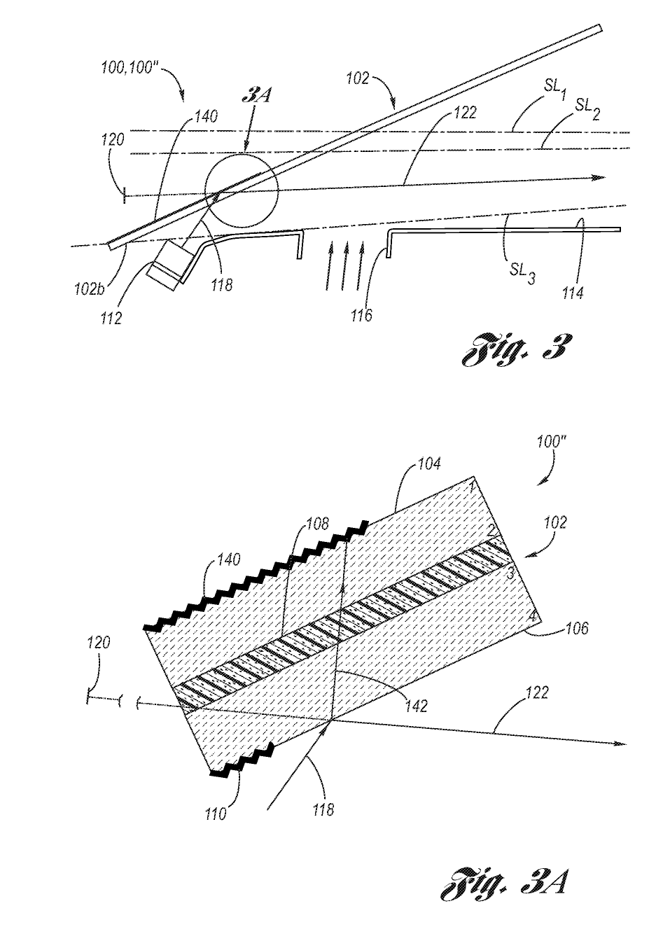

Referring next to FIGS. 3 and 3A, a second aspect 100″ of the virtual image system 100 is depicted.

As similarly recounted with respect to FIGS. 2 and 2A, a laminated windshield 102 is composed of an outer glass pane 104, an inner glass pane 106, a plastic layer 108 therebetween, and a peripheral frit 110, wherein the windshield has surfaces 1, 2, 3 and 4, as generally described hereinabove with respect to FIG. 1. An image source 112 is packaged and mounted within the dashboard 114 of the instrument panel in such a manner (taking due regard for the defrost vent 116) that neither the driver nor an occupant in the passenger compartment will have a direct view of the image source, which may be, for non-limiting example, LED, LCD, VF, OLED, etc. The image source 112 produces real image rays 118 which reflect at the windshield 102 such that a virtual image 120 thereof is viewable to the driver along virtual image rays 122 without a ghost image (virtual or real) being visible to the driver.

In order to provide a high head down virtual image 120 on the laminated windshield 102 without acutely angled outer and inner glass panes and without the appearance of a ghost (i.e., secondary) virtual image, wherein the single virtual image is a crisp, and faithful reproduction of the actual image generated by the image source 112, a matte black material 140 is applied to the outer glass pane 104 at windshield surface 1 in a region thereof in which refracted virtual rays 142, under the well known Snell's Law, transmit through the windshield toward windshield surface 1, wherein the incidence of the real image rays 118 with respect to windshield surface 4 is disposed between sightlines SL₁ and SL₂.

A preferred material for the matte black material 140 is a frit material, as for nonlimiting example a black ceramic powder based material, for example composed of a lead and chromate based ceramic ink or of a water based ceramic ink, which is silk screened onto the windshield, then heated in a furnace to cause it to etch (or frost) into the glass at windshield surface 1.

In operation, the real image rays 118 from the image source strike windshield surface 4, whereupon, under the well known Law of Reflection, the angle of incidence equals the angle of reflection, whereby reflection transpires such that the virtual image rays 122 travel to the driver's eyes, and are seen by the driver as a virtual image 120. The refracted virtual rays 142, refracted under Snell's Law, strike the matte black material 140 and become absorbed, harmlessly scattered or otherwise dissipated such that no ghost image ray is present, and whereby no ghost image (virtual or real) is visible to the driver.

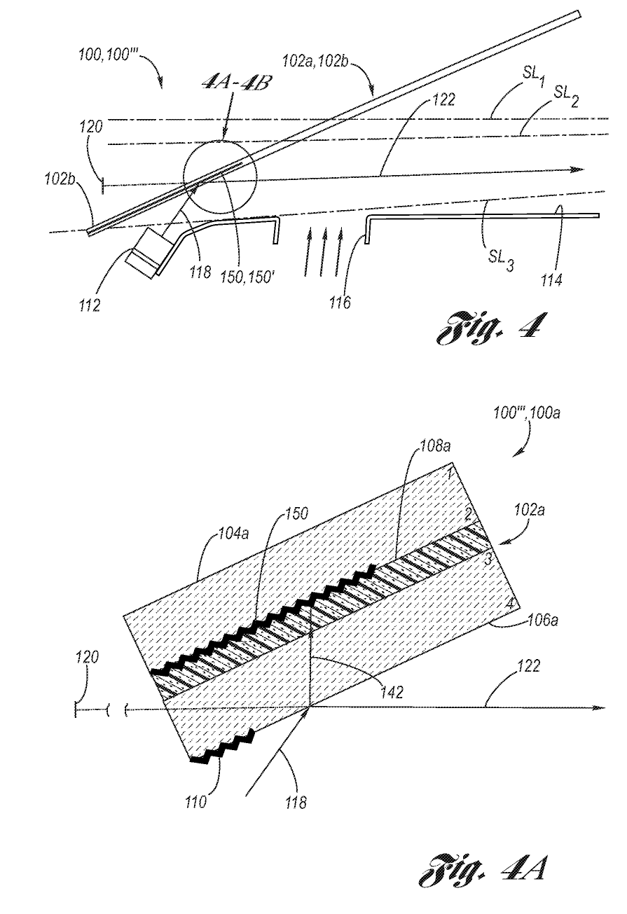

Referring now to FIGS. 4 through 4B, a first application 100a of a third aspect 100′″ of the virtual image system 100 is depicted, particularly at FIG. 4A, and a second application 100b of the third aspect 100′″ of the virtual image system 100 is depicted, particularly at FIG. 4B.

A laminated windshield 102a, 102b is composed of an outer glass pane 104a, 104b an inner glass pane 106a, 106b a plastic layer 108a, 108b therebetween, and a peripheral frit 110, wherein the windshield has surfaces 1, 2, 3 and 4, as generally described hereinabove with respect to FIG. 1. An image source 112 is packaged and mounted within the dashboard 114 of the instrument panel in such a manner (taking due regard for the defrost vent 116) that neither the driver nor an occupant in the passenger compartment will have a direct view of the image source, which may be, for non-limiting example, LED, LCD, VF, OLED, etc. The image source 112 produces real image rays 118 which reflect at the windshield 102a, 102b such that a virtual image 120 thereof is viewable to the driver along virtual image rays 122 without a ghost image (virtual or real) being visible to the driver.

Referring firstly with particularity to FIGS. 4 and 4A, in order to provide a high head down virtual image 120 on the laminated windshield 102a without acutely angled outer and inner glass panes and without the appearance of a ghost (i.e., secondary) virtual image, wherein the single virtual image is a crisp, and faithful reproduction of the actual image generated by the image source 112, a matte black material 150 is applied to the outer glass pane 104a at windshield surface 2 in a region thereof in which refracted virtual rays 142, under well known Snell's Law, transmit through the windshield toward windshield surface 2, wherein the incidence of the real image rays 118 with respect to windshield surface 4 is disposed between sightlines SL₁ and SL₂.

Referring secondly with particularity to FIGS. 4 and 4B, in order to provide a high head down virtual image 120 on the laminated windshield 102b without acutely angled outer and inner glass panes and without the appearance of a ghost (i.e., secondary) virtual image, wherein the single virtual image is a crisp, and faithful reproduction of the actual image generated by the image source 112, a matte black material 150′ is applied to the inner glass pane 106b at windshield surface 3 in a region thereof in which refracted virtual rays 142, under well known Snell's Law, transmit through the windshield toward surface 3, wherein the incidence of the real image rays 118 with respect to windshield surface 4 is disposed between sightlines SL₁ and SL₂.

A preferred material for the matte black material 150, 150′ is a frit material, as for nonlimiting example a black ceramic powder based material, for example composed of a lead and chromate based ceramic ink or of a water based ceramic ink, which is silk screened onto the windshield, then heated in a furnace to cause it to etch (or frost) into the glass at windshield surface 2 or 3, respectively.

In operation with regard to the first application 100a, the real image rays 118 from the image source strike windshield surface 4, whereupon, under the Law of Reflection, the angle of incidence equals the angle of reflection, whereby reflection transpires such that the virtual image rays 122 travel to the driver's eyes, and are seen by the driver as a virtual image 120. The refracted virtual rays 142, refracted under Snell's Law, strike the matte black material 150 and become absorbed, harmlessly scattered or otherwise dissipated such that no ghost image ray is present, and whereby no ghost image (virtual or real) is visible to the driver.

In operation with regard to the second application 100b, the real image rays 118 from the image source strike windshield surface 4, whereupon, under the Law of Reflection, the angle of incidence equals the angle of reflection, whereby transpires whereby the virtual image rays 122 travel to the drive's eyes, and are seen by the driver as a virtual image 120. The refracted virtual rays 142, refracted under Snell's Law, strike the matte black material 150′ and become absorbed, harmlessly scattered or otherwise dissipated such that no ghost image ray is present, and whereby no ghost image (virtual or real) is visible to the driver.

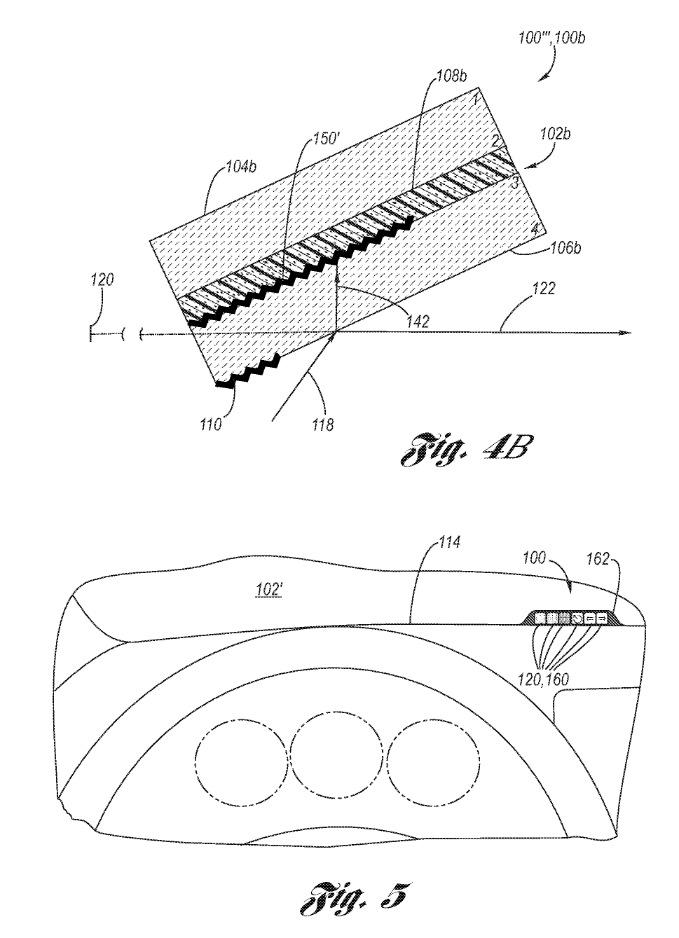

As can be understood by additional reference to FIG. 5, the virtual image system 100 according to the present invention provides the virtual image 120 adjacent the base of the windshield 102′, near the dashboard 114 of the instrument panel as a high contrast image superposed the black background 162, which may be either the glossy black material 130, or the matte black material 140, 150, 150′ which virtual image is easily seen by the driver, wherein by nonlimiting example, the virtual image is in the form of a laterally disposed plurality of side-by-side telltales 160, each telltale delivering information to the driver regarding respectively selected conditions of the motor vehicle. The image seems to appear to the driver to be disposed at a location through the windshield, which is not washed out by sunlight and allows the driver to see the image at a distance whereby minimal head-down movement is required, having the benefits of a HUD without image washout, and wherein for anticipatory compliance with possible regulations, the virtual image is very low on the windshield so as to not affect the driver's general view of the road.

To those skilled in the art to which this invention appertains, the above described preferred embodiment may be subject to change or modification. Such change or modification can be carried out without departing from the scope of the invention, which is intended to be limited only by the scope of the appended claims.

1. A virtual image system, comprising:
a laminated windshield, comprising:
an outer glass pane having a windshield surface 1 and an opposite windshield surface 2;
an inner glass pane having a windshield surface 3 and an opposite windshield surface 4; and
a plastic layer disposed between said outer and inner glass panes, wherein windshield surfaces 2 and 3 abut said plastic layer;
a matte black material disposed on at least one of said windshield surfaces 1, 2 and 3; and
an image source which provides real image rays which are incident at said windshield surface 4;
wherein the real image rays reflect at said windshield surface 4 and thereby provide virtual image rays, the virtual image rays providing a virtual image;
wherein refracted rays of the real image rays which transmit into the windshield strike the matte black material such as to prevent ghost image rays; and
wherein the virtual image is free from ghost image.

2. The virtual image system of claim 1, wherein said matte black material is disposed at said windshield surface 1.

3. The virtual image system of claim 2, wherein said matte black material is a frit material.

4. The virtual image system of claim 3, wherein said matte black material is disposed substantially adjacent a base of the windshield, between a predetermined upper sightline and a predetermined lowest sightline.

5. The virtual image system of claim 1, wherein said matte black material is disposed at said windshield surface 2.

6. The virtual image system of claim 5, wherein said matte black material is a frit material.

7. The virtual image system of claim 6, wherein said matte black material is disposed substantially adjacent a base of the windshield, between a predetermined upper sightline and a predetermined lowest sightline.

8. The virtual image system of claim 1, wherein said matte black material is disposed at said windshield surface 3.

9. The virtual image system of claim 8, wherein said matte black material is a frit material.

10. The virtual image system of claim 9, wherein said matte black material is disposed substantially adjacent a base of the windshield, between a predetermined upper sightline and a predetermined lowest sightline.

11. A virtual image system, comprising:
a laminated windshield, comprising:
an outer glass pane having a windshield surface 1 and an opposite windshield surface 2;
an inner glass pane having a windshield surface 3 and an opposite windshield surface 4; and
a plastic layer disposed between said outer and inner glass panes, wherein windshield surfaces 2 and 3 abut said plastic layer;
a black glossy sheet disposed at said windshield surface 4; and
an image source which provides real image rays which are incident at said black glossy sheet;
wherein the real image rays reflect at said black glossy sheet and thereby provide virtual image rays, the virtual image rays providing a virtual image; and
wherein the virtual image is free from ghost image.

12. The virtual image system of claim 11, wherein:
said laminated windshield further comprises a peripheral frit located on said windshield surface 4; and wherein
said glossy black sheet is adhered to said frit, wherein said frit is at least co-extensive with said glossy black sheet.

13. The virtual image system of claim 12, wherein said black glossy sheet is a self-adhering mylar applique.

14. The virtual image system of claim 13, wherein said black glossy sheet is disposed substantially adjacent a base of the windshield, between a predetermined upper sightline and a predetermined lowest sightline.

15. A laminated windshield, comprising:
an outer glass pane having a windshield surface 1 and an opposite windshield surface 2;
an inner glass pane having a windshield surface 3 and an opposite windshield surface 4;
a plastic layer disposed between said outer and inner glass panes, wherein windshield surfaces 2 and 3 abut said plastic layer; and
a matte black material disposed on at least one of said windshield surfaces 1, 2 and 3.

16. The laminated windshield of claim 15, wherein:
said matte black material is disposed at said windshield surface 1;
said matte black material is a frit material; and
said matte black material is disposed substantially adjacent a base of the windshield, between a predetermined upper sightline and a predetermined lowest sightline.

17. The laminated windshield of claim 15, wherein:
said matte black material is disposed at said windshield surface 2;
said matte black material is a frit material; and
said matte black material is disposed substantially adjacent a base of the windshield, between a predetermined upper sightline and a predetermined lowest sightline.

18. The laminated windshield of claim 15, wherein:
said matte black material is disposed at said windshield surface 3;
said matte black material is a frit material; and
said matte black material is disposed substantially adjacent a base of the windshield, between a predetermined upper sightline and a predetermined lowest sightline.

19. A laminated windshield, comprising:
an outer glass pane having a windshield surface 1 and an opposite windshield surface 2;
an inner glass pane having a windshield surface 3 and an opposite windshield surface 4;
a plastic layer disposed between said outer and inner glass panes, wherein windshield surfaces 2 and 3 abut said plastic layer;
a peripheral frit located on said windshield surface 4; and
a black glossy sheet disposed on the frit of said windshield surface 4.

20. The laminated windshield of claim 19, wherein:
said black glossy sheet is a self-adhering mylar applique; and
said black glossy sheet is disposed substantially adjacent a base of the windshield, between a predetermined upper sightline and a predetermined lowest sightline.
